(19) United States
(12) Patent Application Publication
(10) Pub. No.: US 2010/0259744 A1
(43) Pub. Date: Oct. 14, 2010

(54) SPECTRAL FILTER, LITHOGRAPHIC APPARATUS INCLUDING SUCH A SPECTRAL FILTER, DEVICE MANUFACTURING METHOD, AND DEVICE MANUFACTURED THEREBY

(75) Inventors: Maarten Marinus Johannes Wilhelmus Van Herpen, Heesch (NL); Vadim Yevgenyevich Banine, Helmond (NL); Wouter Anthon Soer, Nijmegen (NL)

Correspondence Address: PILLSBURY WINTHROP SHAW PITTMAN, LLP, P.O. BOX 10500, MCLEAN, VA, 22102, US

(73) Assignee: ASML Netherlands B.V.

(21) Appl. No.: 12/680,364

(22) PCT Filed: Sep. 26, 2008
(86) PCT No.: PCT/NL08/50622

§ 371 Date: Mar. 26, 2010

Related U.S. Application Data
(60) Provisional application No. 60/975,764, filed on Sep. 27, 2007.

(51) Int. Cl. G03B 27/72

(52) U.S. Cl. 355/71; 355/77

(57) ABSTRACT

A lithographic spectral filter including a first filter element including a slit having an in plane length dimension arranged in a first direction; and a second filter element arranged at a subsequent position along an optical path of radiation of first and second wavelengths to the first filter element, the second filter element including a slit having an in plane length dimension arranged in a second direction transverse to the first direction, wherein the spectral filter is configured to reflect radiation of a first wavelength and allow transmission of radiation of a second wavelength, the first wavelength being larger than the second wavelength.

### FIELD

The present invention relates to a spectral filter, a lithographic apparatus including such a spectral filter, a device manufacturing method and a device manufactured thereby.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

As the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{{NA}_{PS}} \qquad ( 1 )$$

where λ is the wavelength of the radiation used, NA_{PS} is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA_{PS} or by decreasing the value of k₁.

In order to shorten the exposure wavelength and, thus, reduce the printable size, it has been proposed to use extreme ultraviolet (EUV) radiation (sometimes referred to as soft x-ray). An EUV radiation source is configured to output a radiation wavelength of about 13 nm, a wavelength in the BUY radiation range. EUV radiation may constitute a significant step toward achieving small features printing. Possible sources of such radiation include, for example, a laser-produced plasma source, a discharge plasma source, or synchrotron radiation from an electron storage ring.

In addition to BUY radiation, a radiation source used in BUY radiation lithography may additionally emit different wavelengths of radiation. This non-EUV radiation may be harmful for the EUV radiation lithography system, and is desirably kept out of the optical path downstream of the radiation source, such as the illumination system and projection system which are respectively used to condition an BUY radiation beam and project the beam onto a substrate. Accordingly it is desirable to provide spectral filtering to the radiation coming from an BUY radiation source.

A spectral filter based on a blazed grating is known. This grating may be difficult to produce, since the surface quality of the triangular shaped pattern has to be very high. The roughness of the surface should be lower than 1 nm RMS. A debris mitigation scheme is also applied to suppress debris originating from the radiation source. However, debris mitigation may be problematic as a debris mitigation method, such as a foil trap and/or gas buffer, may not guarantee effective debris protection. Moreover, use of a thin filter (e.g. Zr) transmissive for EUV radiation is difficult due to the fragility of the filter and low heat-load threshold. In addition the glue used for a filter on mesh is not desirable for a high vacuum system.

U.S. Pat. No. 6,456,362, incorporated herein in its entirety by reference, discloses a waveguide for use in an EUV radiation lithographic projection apparatus.

U.S. Pat. No. 6,809,327, incorporated herein in its entirety by reference, discloses an apparatus including a plasma source to generate a spectrum of radiation that includes BUY radiation, a reflector to generate a beam of EUV radiation from the spectrum of radiation, and a thin film to pass at least a portion of the EUV radiation.

U.S. Patent Application Publication No. US 2006/0146413 describes a spectral filter comprising an aperture. In an example, a first wavelength is in the infrared range, while a second wavelength is in the EUV radiation range. In an embodiment the spectral filter comprises a plurality of apertures in the form of slits.

### SUMMARY

A problem with existing spectral filters is that they change the direction of the radiation from the EUV radiation source. Therefore, if a spectral filter is removed from an EUV radiation lithography apparatus, a replacement spectral filter has to be added or a mirror at a proper angle has to introduced. The added mirror introduces unwanted losses into the system.

An advantage of slits in a spectral filter compared to pinholes is that slits may be easier to manufacture and that slits may have better tolerance for temperature change. In an embodiment, the slit reflects radiation having wavelengths that should be suppressed, while transmitting radiation with a sufficiently low wavelength such as EUV radiation. To that end the slits of the spectral filter should have a width at least twice as small as the wavelength of the undesired radiation. Due to polarization dependent effects, only a part of the undesired radiation may be reflected in this embodiment. In an embodiment of a spectral filter from United States Patent Application Publication No. US 2006/0146413, the undesired radiation is reduced by a combination of diffraction and absorption. The undesired radiation is diffracted relatively strongly and is subsequently absorbed within the slit after one or more internal reflections. The desired radiation is substantially less diffracted and passes relatively unweakened through the filter. A disadvantage of this embodiment may be that the absorbed radiation heats the filter.

It is desired, for example, to further reduce the transmission of undesired radiation.

According to an aspect, there is provided a lithographic spectral filter, comprising:

a first filter element comprising a slit having an in plane length dimension arranged in a first direction; and

a second filter element arranged at a subsequent position along an optical path of radiation of first and second wavelengths to the first filter element, the second filter element comprising a slit having an in plane length dimension arranged in a second direction transverse to the first direction,

wherein the spectral filter is configured to reflect radiation of a first wavelength and allow transmission of radiation of a second wavelength, the first wavelength being larger than the second wavelength.

According to a further aspect, a lithographic apparatus is provided comprising:

an illumination system configured to condition a radiation beam;

a support configured to support a patterning device, the patterning device configured to impart the radiation beam with a pattern in its cross-section to form a patterned radiation beam;

a substrate table configured to hold a substrate;

a projection system configured to project the patterned radiation beam onto a target portion of the substrate; and

a lithographic spectral filter, comprising:
a first filter element comprising a slit having an in plane length dimension arranged in a first direction, and
a second filter element arranged at a subsequent position along an optical path of radiation of first and second wavelengths to the first filter element, the second filter element comprising a slit having an in plane length dimension arranged in a second direction transverse to the first direction,
wherein the spectral filter is configured to reflect radiation of a first wavelength and allow transmission of radiation of a second wavelength, the first wavelength being larger than the second wavelength.

According to an aspect, there is provided a method for enhancing the spectral purity of a radiation beam by reflecting radiation of a first wavelength and allowing radiation of a second wavelength to transmit through a spectral filter assembly, the first wavelength being larger than the second wavelength, wherein in a first step radiation of the first wavelength with a first polarization is reflected and in a second step radiation of the first wavelength with a second polarization, transverse to the first polarization, is reflected.

According to an aspect, there is provided a device manufacturing method, comprising:

providing a radiation beam;

patterning the radiation beam;

projecting a patterned beam of radiation onto a target portion of a substrate; and

enhancing the spectral purity of a radiation beam by reflecting radiation of a first wavelength and allowing radiation of a second wavelength to transmit through a spectral filter assembly, the first wavelength being larger than the second wavelength, wherein in a first step radiation of the first wavelength with a first polarization is reflected and in a second step radiation of the first wavelength with a second polarization, transverse to the first polarization, is reflected.

According to an aspect, a device is provided that is manufactured according to a method comprising:

providing a radiation beam;

patterning the radiation beam;

projecting a patterned beam of radiation onto a substrate;

projecting a patterned beam of radiation onto a substrate;

enhancing the spectral purity of the radiation beam by reflecting radiation of a first wavelength and allowing radiation of a second wavelength to transmit through a spectral filter assembly, the first wavelength being larger than the second wavelength, wherein in a first step radiation of the first wavelength with a first polarization is reflected and in a second step radiation of the first wavelength with a second polarization, transverse to the first polarization, is reflected.

The spectral filter elements may be formed of a slab of material that is not transparent (examples are a metal such as gold (Au), silver (Ag), chromium (Cr), aluminum (Al), molybdenum (Mo), ruthenium (Ru), or stainless steel). The slit in the first spectral filter element has an in plane width that defines a first in-plane vector with a first direction, and a length transverse thereto that defines a second in-plane vector with a second direction. The first and the second in-plane vectors are parallel to the slab of material. The first (smallest) in-plane slit dimension is parallel to the first in-plane vector and the second (largest) in-plane aperture dimension is parallel to the second in-plane vector.

The smallest in plane slit dimension (W1) is smaller than a diffraction limit, the diffraction limit (Wₘᵢₙ) defined by a medium for containing the target components:

Wₘᵢₙ=wavelength/(2*n_{medium}) (2)

with λ is the wavelength in vacuum and n_{medium} the refractive index of the medium in front of the slit.

With a slit having a first in-plane dimension W1 below the diffraction limit and a second in-plane dimension W2 above the diffraction limit, there may be a transmission plane that is composed of the first in-plane vector and a third vector that is normal to the first and second in-plane vectors. R-polarized incident radiation, that is radiation having an electric field orthogonal to the plane of transmission of the slit, would be substantially reflected by the slit. T-polarized incident radiation, that is radiation having an electric field parallel to the plane of transmission of the slit, would be substantially transmitted by the slit.

It is believed that the T-polarized radiation is transmitted through the filter because a reinforcement occurs in the form of a surface plasmon wave. This effect does not occur when a relatively wide slit is applied.

In the spectral filter according to an embodiment of the invention, the second filter element comprises a first slit having an in plane length dimension arranged in a second direction transverse to the first direction. Accordingly, undesired radiation of the first wavelength that passes the first filter element is reflected by the second filter element as this radiation is R-polarized radiation, i.e. forms radiation having an electric field orthogonal to the plane of transmission of the slit in the second filter element.

The filter elements reflect radiation if the slit width is smaller than the diffraction limit. Desirably the width of the slit is selected from a range of 0.01 λr to 0.5 λr, wherein λr is the shortest wavelength of the radiation to be reflected. If the width of the slit is much smaller than the lower boundary, e.g. a 0.005 λr, the slit may also partly reflect desired radiation. If the width is much larger than the higher boundary, e.g. 0.8 λr, the undesired radiation may be transmitted through the slit.

In an embodiment, the lithographic spectral filter is configured to filter any combination of DUV, UV, visible and IR radiation. Apart from IR radiation, the radiation source may produce undesired radiation in the visible range, the UV range and the DUV range. Hence it is desirable if also radiation in one or more of these additional wavelength ranges can be suppressed. In an embodiment, this is realized by selecting the width of the slit of the first and/or the second filter element at a value smaller than the diffraction limit of the smallest wavelength of the undesired radiation.

Instead of suppressing all undesired radiation by reflection, a part may be suppressed by absorption. This may be, for example, realized in an embodiment wherein the first and/or the second filter element further comprises an EUV radiation waveguide. Due to diffraction at the opening of the filter element wherein the waveguide is comprised, radiation with a relatively large wavelength is diffracted at relatively large angles as compared to the desired radiation, having a relatively short wavelength. Due to this diffraction at large angles, radiation having a wavelength between the first and the second wavelength is reflected in the waveguide at relatively large angles relative to an inner wall of the waveguide as compared to the desired radiation with the second wavelength or smaller. Therefore, the radiation having a wavelength between the first wavelength and the second wavelength requires a higher number of reflections to pass through the waveguide than the desired radiation. The desired radiation is transmitted relatively unweakened through the EUV radiation waveguide.

In an embodiment, the waveguide is made of a material capable of absorbing radiation in a wavelength range between the first wavelength and the second wavelength. In this embodiment the undesired radiation with a wavelength between the first wavelength and the second wavelength is even better suppressed with the same length of the waveguide. The transmission of the desired radiation can be improved, while maintaining the same absorption of the undesired radiation in the waveguide, by selecting a shorter length of the waveguide. The slit in the filter element may already form a waveguide provided that the filter element has a sufficient thickness. For example, the slit may have a depth/width ratio of at least 2. The depth/width ratio is desirably less than 10, for example 5. A substantially higher depth/width ratio, e.g. 20, would result in a too strong reduction of the desired radiation and may be difficult to manufacture.

Although the spectral filtering effect may be achieved when the first and/or the second filter element has a single slit, it is advantageous if one or more of the filter elements has a plurality of slits. This makes it possible to filter a larger part or the entire beam of the radiation so that the transmission of desired radiation is improved.

In an embodiment of the lithographic spectral filter, an aspect ratio formed between an area formed by the slits of the first filter element and a total surface area of the first filter element is smaller than about 50%, smaller than about 30%, or smaller than about 15%.

In an embodiment of the lithographic spectral filter, an aspect ratio formed between an area formed by the slits of the second filter element and a total surface area of the first filter element is smaller than about 50%, smaller than about 30%, or smaller than about 15%.

A high aspect ratio is favorable for the transmissivity of the filter for the desired radiation.

Where the radiation having a wavelength in the range between the first and the second wavelength is absorbed, it is sufficient if only radiation with the first wavelength is reflected. In a practical application the undesired radiation is infrared radiation with a wavelength of about 10 μm, generated by a CO₂ laser source of a laser-produced plasma EUV radiation source. Radiation in this range may be effectively reflected with a lithographic spectral filter wherein the slit of the first and/or the second filter element has a width selected from the range of 0.5-5 μm. Further radiation in the visible range, the near and the deep UV range may be removed by absorption, for example in a waveguide as described above, or another, unpatterned, type of absorption filter e.g. a Si₃N₄ filter. A mechanism for suppressing such further radiation may be absent if the radiation source does not substantially generate such further radiation, and/or if the further radiation would not be detrimental to the application wherein the lithographic spectral filter is used.

The spectral filter may be situated behind a collector in the lithographic apparatus.

At least one grazing incidence filter may also be present in the lithographic apparatus.

The manufactured device may be an integrated circuit, an integrated optical system, a guidance and detection pattern for a magnetic domain memory, a liquid crystal display, or a thin-film magnetic head.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a lithographic apparatus according to an embodiment of the invention;

FIG. 3 depicts a lithographic spectral impurity filter according to an embodiment of the invention;

FIG. 4 depicts a lithographic spectral impurity filter according to an embodiment of the invention;

FIG. 5 depicts a filter element in a lithographic spectral impurity filter according to an embodiment of the invention; and

FIG. 6 depicts a filter element in a lithographic spectral impurity filter according to an embodiment of the invention.

### DETAILED DESCRIPTION

In the following detailed description numerous specific details are set forth in order to provide a thorough understanding of an embodiment of the present invention. However, it will be understood by one skilled in the art that the present invention may be practiced without these specific details. In other instances, well known methods, procedures, and components have not been described in detail so as not to obscure aspects of the present invention.

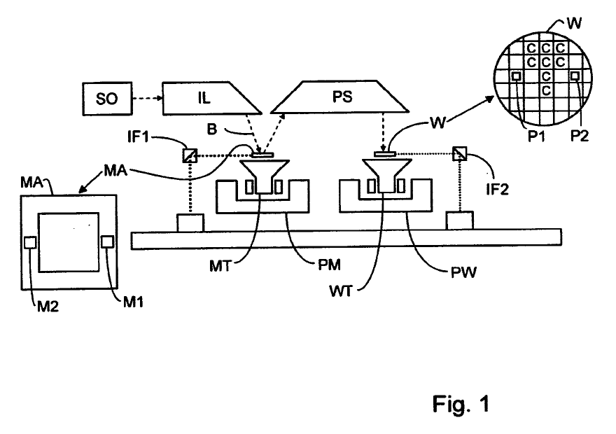

FIG. 1 schematically depicts a lithographic apparatus according to one embodiment of the invention. The apparatus comprises:
an illumination system (illuminator) IL configured to condition a radiation beam B (e.g. UV radiation or EUV radiation);
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device in a manner that depends on the orientation of the patterning device, the design of the lithographic apparatus, and other conditions, such as for example whether or not the patterning device is held in a vacuum environment. The support structure MT can use mechanical, vacuum, electrostatic or other clamping techniques to hold the patterning device. The support structure MT may be a frame or a table, for example, which may be fixed or movable as required. The support structure MT may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more patterning device support structures). In such “multiple stage” machines the additional tables and/or support structures may be used in parallel, or preparatory steps may be carried out on one or more tables and/or support structures while one or more other tables and/or support structures are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus, for example when the source is a mercury lamp. The source SO and the illuminator IL, together with the beam delivery system if required, may be referred to as a radiation system.

The illuminator IL may comprise an adjuster to adjust the angular intensity distribution of the radiation beam. Generally, at least the outer and/or inner radial extent (commonly referred to as s-outer and s-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the patterning device MA with respect to the path of the radiation beam B, e.g. after mechanical retrieval from a mask library, or during a scan. In general, movement of the patterning device support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the patterning device support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the patterning device support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the patterning device support structure MT and the substrate table WT are scanned synchronously while a pattern imparted to the radiation beam is projected onto a target portion C (i.e. a single dynamic exposure). The velocity and direction of the substrate table WT relative to the patterning device support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

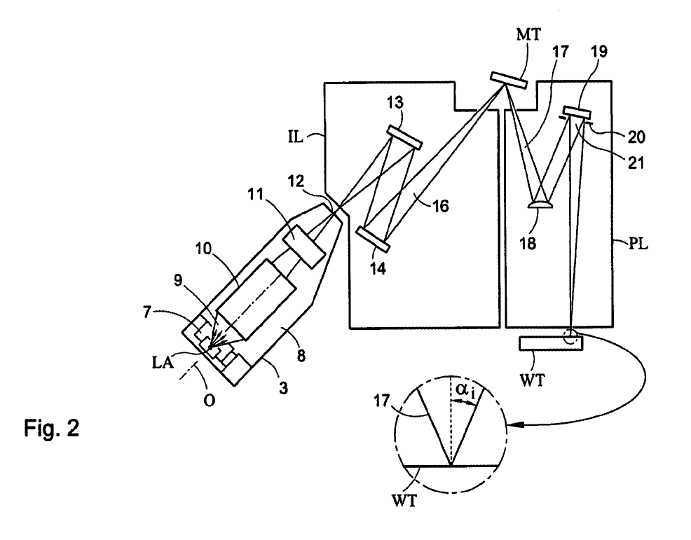

FIG. 2 shows a side view of an BUY radiation lithographic apparatus in accordance with an embodiment of the present invention. It will be noted that, although the arrangement is different to that of the apparatus shown in FIG. 1, the principle of operation is similar. The apparatus includes a radiation unit 3 (e.g., a source-collector module), an illumination system IL and a projection system PL. Radiation unit 3 is provided with a radiation source LA which may employ a gas or vapor, such as Xe gas or Li vapor in which a very hot discharge plasma is created so as to emit radiation in the EUV radiation range. The discharge plasma is created by causing a partially ionized plasma of an electrical discharge to collapse onto the optical axis O. A partial pressure of 0.1 mbar of Xe gas or Li vapor or any other suitable gas or vapor may be used for efficient generation of the radiation. The radiation emitted by radiation source LA is passed from the source chamber 7 into collector chamber 8 via a gas barrier and/or foil trap 9. The foil trap includes a channel structure such as, for instance, described in detail in U.S. Pat. No. 6,614,505 and U.S. Pat. No. 6,359,969, which are incorporated herein in their entirety by reference. The collector chamber 8 includes a radiation collector 10 which is formed, for example, by a grazing incidence collector. Radiation passed by collector 10 transmits through a spectral filter 11 according to an embodiment of the present invention. It should be noted that in contrast to a blazed spectral filter, the spectral filter 11 does not substantially change the direction of the radiation beam. In an embodiment, not shown, the spectral filter 11 may reflect the radiation beam as the spectral filter 11 may be implemented in the form of a grazing incidence mirror or on the collector 10. The radiation is focused in a virtual source point 12 (i.e. an intermediate focus) at or near an aperture in the collection chamber 8. From chamber 8, the radiation beam 16 is reflected in illumination system IL via normal incidence reflectors 13,14 onto a patterning device on patterning device support structure MT. A patterned beam 17 is formed which is imaged by projection system PL via reflective elements 18,19 onto substrate table WT. More or less elements than shown may generally be present in the illumination system IL and/or projection system PL.

One of the reflective elements 19 has in front of it a numerical aperture disc 20 having an aperture 21 therethrough. The size of the aperture 21 determines the angle αᵢ subtended by the patterned radiation beam 17 as it strikes the substrate table WT.

FIG. 2 shows the spectral filter 11 according to an embodiment of the present invention positioned downstream of the collector 10 and upstream of the virtual source point 12. In an embodiment, not shown, the spectral filter 11 may be positioned at the virtual source point 12 or at any point between the collector 10 and the virtual source point 12.

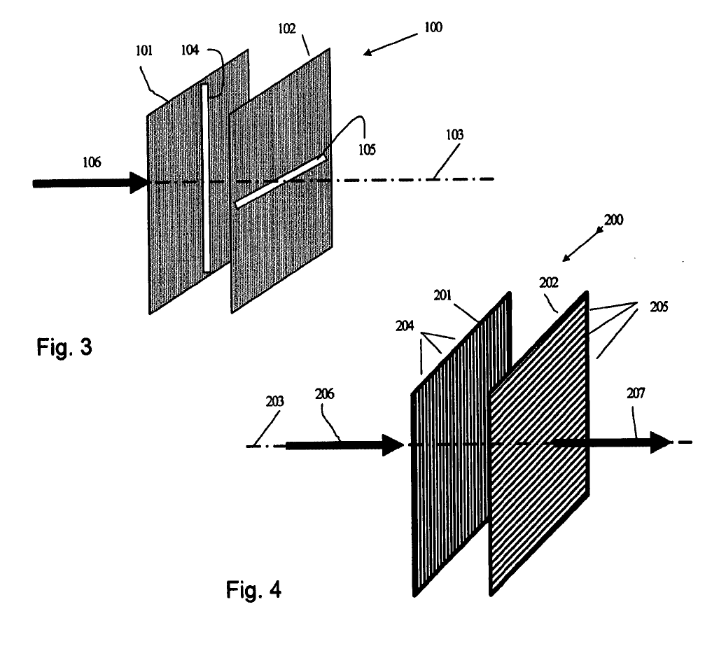

FIG. 3 shows an embodiment of a lithographic spectral filter 100 comprising at least a first and a second filter element 101, 102 arranged transversely at subsequent positions along an optical axis 103.

The first filter element 101 comprises a first slit 104 arranged in a first direction. The slit 104 has a first in-plane dimension W1 below the diffraction limit and a second in-plane dimension W2 above the diffraction limit. The first in-plane dimension determines a width (e.g., diameter) and the second in-plane dimension determines a length. The second filter element 102 comprises a first slit 105 arranged in a second direction transverse to the first direction. Likewise, the second slit 105 has a first in-plane dimension W1 below the diffraction limit and a second in-plane dimension W2 above the diffraction limit. The first in-plane dimension determines a width (e.g., diameter) and the second in-plane dimension determines a length. The spectral filter 100 is configured to enhance the spectral purity of a radiation beam by reflecting radiation of a first wavelength and allowing transmission of radiation of a second wavelength, the first wavelength being larger than the second wavelength. By way of example, the first wavelength is in the range of 5-15 μm, e.g. 10.6 μm and the second wavelength is in the range of 4 to 50 nm e.g. in the range of 4-15 nm, for example 13.5 nm. In the example the slits 104, 105 have a width in the range of 0.5-2 μm and a length of for example 0.5-10 cm. The first filter element reflects a polarization component of the undesired radiation with its E-field vector parallel to the first direction. The second filter element reflects a polarization component of the undesired radiation with its E-field vector parallel to the second direction. The spectral filter elements 101, 102, in particular, adjacent the slit apertures of spectral filter elements 101,102, are desirably provided by metal. The reflective properties can be advantageous for metal apertures and, in addition, so is the thermal conductivity. The slit may have a depth in the range of 1-1000 μm.

FIG. 4 shows a further embodiment of the spectral filter 200. Parts therein corresponding to those in FIG. 3 have reference numerals that are 100 higher than in FIG. 3. In the embodiment of FIG. 4, the first filter element 201 comprises a plurality of slits 204. An aspect ratio formed between an area formed by the slits 204 of the first filter element 201 and a remaining surface area of the first filter element 201 is greater than about 30%. Likewise, the second filter element 202 comprises a plurality of slits 205. An aspect ratio formed between an area formed by the slits 205 of the second filter element 202 and a remaining surface area of the second filter element 202 is greater than about 30%.

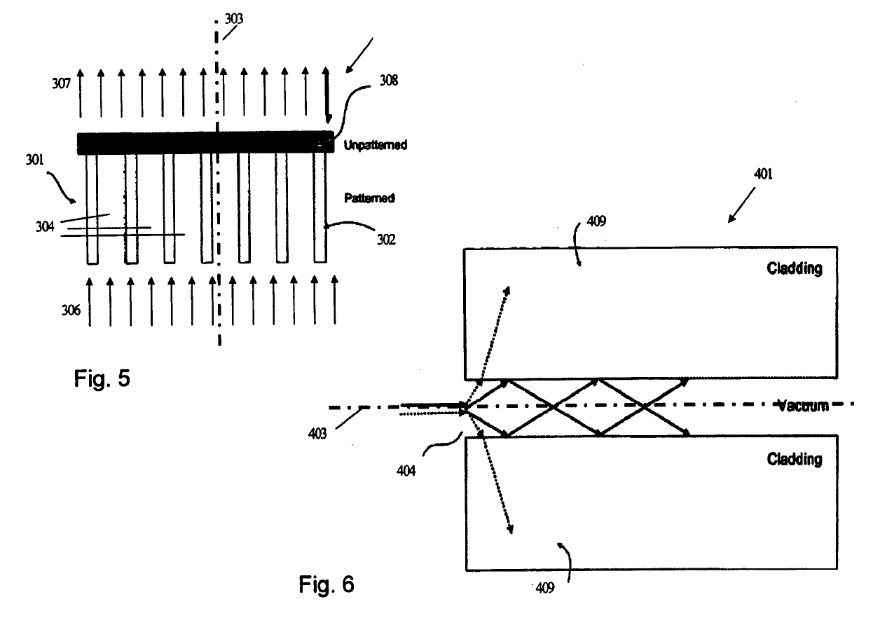

FIG. 5 shows a filter element 301 with a combination of a patterned and an unpatterned layer in order to increase the mechanical strength of a spectral filter 300. In FIG. 5 parts corresponding to those in FIG. 3 have reference numerals that are 200 higher than in FIG. 3. In FIG. 5, the arrows indicate the direction of the EUV radiation. A combination of patterned layer 302 and unpatterned layer 308 as shown in FIG. 5 increases the mechanical strength of the spectral filter 300. Slits 304 are formed in the patterned layer 302. It should be noted that by using a patterned layer 302 and an unpatterned layer 308, the pattern of slits 304 can be used to suppress longer wavelengths, such as infrared (IR), while the unpatterned layer can be used to suppress UV wavelengths.

In this embodiment, the patterned layer 302 acts as a substrate/support for the unpatterned layer 308. Moreover, the spectral filter acts as a cascade of an unpatterned filter and a patterned filter. Therefore, the suppression will be better than the suppression of an unpatterned filter with, for a sufficiently sparsely patterned layer, only a small reduction in the EUV radiation transmission. The suppression by a patterned filter is a geometric effect and improves with increasing wavelength. Therefore, the combination of a patterned and unpatterned layer/stack has the potential of a higher infrared-suppression than an unpatterned layer/stack. To suppress infrared wavelengths, the slits 304 can have a width of about 1 μm. The thickness of the unpatterned layer 308 may be about 50-100 nm and the thickness of the patterned layer 302 may vary between about 1-1000 μm, depending on whether or not a waveguide-effect is used.

Using an unpatterned layer and a patterned layer therefore improves the mechanical strength compared with a spectral filter which has only an unpatterned (e.g. a thin slab) or patterned (e.g. a spectral filter as shown in FIGS. 3 and 4) layer.

Due to the improved strength of the spectral filter shown in FIG. 5, the thickness of the unpatterned layer may be reduced, which results in improved EUV radiation transmission. The thickness may be reduced to about 50-100 nm. As an example, using a Si₃N₄ stack and reducing the thickness of the unpatterned Si₃N₄ layer to 50 nm results in an EUV radiation transmission of 65% and DUV transmission (wavelength of 157 nm) of still 1.6%. As both the unpatterned and patterned layer act as a spectral filter, this results in an improved optical performance of the spectral filter. The implementation as shown in FIG. 5 may be applied to either the first or the second filter element or both.

A further embodiment of a spectral filter element is shown in FIG. 6. Parts therein corresponding to those in FIG. 3 have reference numerals that are 300 higher than in FIG. 3. The spectral filter element 401 in FIG. 6 includes a slit 404 connected to an EUV radiation waveguide which is formed by cladding 409 on both sides of a vacuum space. As shown in FIG. 6, the waveguide behind the slit 404 is of the same width as the aperture 404 itself. Although it is possible to use a waveguide with a smaller/larger width than the slit 404, this results in a larger/smaller suppression of the unwanted wavelengths and also results in a smaller/larger transmission of EUV radiation.

The spectral filter element 401 shown in FIG. 6 therefore is a 3-layer stack of a thin vacuum layer sandwiched between two cladding layers 409 forming a waveguide.

For proper operation of the spectral filter element 401, the material of the waveguide should be absorbing of wavelengths that one wants to suppress with the spectral filter. There are no specific requirements for the EUV radiation transmission of the material. As an example, for a filter that is used to suppress DUV wavelengths, Si₃N₄ is a good candidate, because it has a high absorption for DUV: −400 dB/cm for a wavelength of 150 nm.

For a single slit, thickness can in principle be infinite. For an array of slits/pinholes, the thickness should desirably be larger than a decay length of radiation in the absorbing cladding material in order to avoid optical coupling between the radiation in adjacent pinholes/slits, which is for a sufficiently absorbing material in the order of a few 100 nm.

FIG. 6 represents the operating principle of the spectral filter element 401 wherein the EUV radiation travels along the waveguide and UV radiation transmits through the cladding 409 of the waveguide. IR radiation with a polarization is reflected. The wavelength selectivity of the spectral filter element 401 is due to wavelength selective diffraction at the input aperture in combination with reduced reflection at the vacuum-interfaces for larger grazing angles of incidence. From diffraction theory, the divergence angle due to diffraction at a narrow aperture (e.g. pinhole/slit) is proportional with the ratio of wavelength/width. Therefore, at the vacuum-cladding interface, larger wavelengths have larger grazing angles with respect to the vacuum-cladding interface than smaller wavelengths. In situations such as for grazing angles smaller than the Brewster angle, the Fresnel reflection at an interface decreases with increasing grazing angle and also the number of reflections per unit propagation length in the waveguide increases with increasing grazing angle. It therefore follows that the transmission of the spectral filter decreases with increasing wavelength.

The pattern of the spectral filter element 201 shown in FIG. 4 may be used in this embodiment with different slit widths. It is desirable that the width of the slit shown in FIG. 6 has a width of about 1 μm followed by a waveguide which is used to suppress radiation with wavelengths larger than EUV radiation. The performance of the spectral filter can be improved by varying the width of the slit and length of the waveguide.

Typically, the width of the aperture is around 1 μm. As an example, consider a transmission for a 1 μm wide slit having a length and an input beam with a realistic angular spread of ±7°. After 150 μm propagation along the waveguide, the EUV radiation transmission is 50% while the UV suppression relative to EUV radiation is better than −10 dB.

Taking into account that in practice the image in the intermediate focus of a lithographic apparatus has a width (diameter) in the order of 10 mm, it follows that an array, for example an a-periodic array, of apertures should be used in order to reduce the propagation losses for EUV radiation.

The overall transparency of a spectral filter element comprising an array of slits and/or pinholes is determined by the ratio between the transparent and non-transparent area of the spectral filter. As an example, consider a 1 μm wide slit with a length of 150 μm having an EUV radiation transmission of −3 dB (50%) per slit. In this case, 80% of the spectral filter area is transparent, resulting in an overall transmission of 40%. Accordingly the transmission of the spectral filter comprising a first and a second filter element is 16%.

As previously described, the spectral filter can be manufactured by known lithographic and/or micro-machining techniques. As an example, a Si-substrate with a Si₃N₄ layer on top may be used. By etching from the backside of the Si-substrate up to the Si₃N₄ layer, the patterned layer can be defined. The patterned and unpatterned layers may be formed from the same piece of material or alternatively formed separately and thereafter attached to one another.

The spectral filters as described above may be used in any suitable type of lithographic apparatus. Moreover, the spectral filter may be used in combination with at east one grazing incidence mirror in a lithographic apparatus.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. It should be appreciated that, in the context of such alternative applications, any use of the term “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The descriptions above are intended to be illustrative, not limiting. Thus, it should be appreciated that modifications may be made to the present invention as described without departing from the scope of the claims set out below.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm), X-ray and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

In the claims the word “comprising” does not exclude other elements or steps, and the indefinite article “a” or “an” does not exclude a plurality. A single component or other unit may fulfill the functions of several items recited in the claims. The mere fact that certain measures are recited in mutually different claims does not indicate that a combination of these measures cannot be used to advantage. Any reference signs in the claims should not be construed as limiting the scope.

1. A lithographic spectral filter, comprising:
a first filter element comprising a slit having an in plane length dimension arranged in a first direction; and
a second filter element arranged at a subsequent position along an optical path of radiation of first and second wavelengths to the first filter element, the second filter element comprising a slit having an in plane length dimension arranged in a second direction transverse to the first direction,
wherein the spectral filter is configured to reflect radiation of a first wavelength and allow transmission of radiation of a second wavelength, the first wavelength being larger than the second wavelength.

2. The lithographic spectral filter of claim 1, wherein the slits of first and second filter elements have a smallest in plane aperture dimension smaller than a diffraction limit defined by the first radiation wavelength.

3. The lithographic spectral filter of claim, wherein the first filter element comprises a plurality of slits.

4. The lithographic spectral filter of claim 3, wherein an aspect ratio formed between an area formed by the slits of the first filter element and a total surface area of the first filter element is smaller than about 30%.

5. The lithographic spectral filter of claim 1, wherein the second filter element comprises a plurality of slits.

6. The lithographic spectral filter of claim 5, wherein an aspect ratio formed between an area formed by the slits of the second filter element and a total surface area of the second filter element is smaller than about 30%.

7. The lithographic spectral filter of claim 1, wherein the slit of the first and/or the second filter element has a width selected from the range of 0.5-5 μm.

8. The lithographic spectral filter of claim 1, wherein the spectral filter is configured to filter any combination of DUV, UV, visible and IR radiation.

9. The lithographic spectral filter of claim 1, wherein the first and/or the second filter element further comprises an EUV radiation waveguide.

10. The lithographic spectral filter of claim 1, wherein the first and/or the second filter element comprises a combination of a patterned layer and an unpatterned layer, the patterned layer comprising the slit.

11. The lithographic spectral filter of claim 1 in combination with at least one grazing incidence mirror.

12. The lithographic spectral filter of claim 1, wherein the spectral filter is configured to transmit EUV radiation with a wavelength selected from the range of about 4-20 nm.

13. The lithographic spectral filter of claim 1, wherein the first and the second filter elements are arranged transversely at subsequent positions along the optical path.

14. A lithographic apparatus, comprising:
an illumination system configured to condition a radiation beam;
a support configured to support a patterning device, the patterning device configured to impart the radiation beam with a pattern in its cross-section to form a patterned radiation beam;
a substrate table configured to hold a substrate;
a projection system configured to project the patterned radiation beam onto a target portion of the substrate; and
a lithographic spectral filter, comprising:
a first filter element comprising a slit having an in plane length dimension arranged in a first direction, and
a second filter element arranged at a subsequent position along an optical path of radiation of first and second wavelengths to the first filter element, the second filter element comprising a slit having an in plane length dimension arranged in a second direction transverse to the first direction,
wherein the spectral filter is configured to reflect radiation of a first wavelength and allow transmission of radiation of a second wavelength, the first wavelength being larger than the second wavelength.

15. A method for enhancing the spectral purity of a radiation beam by reflecting radiation of a first wavelength and allowing radiation of a second wavelength to transmit through a spectral filter assembly, the first wavelength being larger than the second wavelength, wherein in a first step radiation of the first wavelength with a first polarization is reflected and in a second step radiation of the first wavelength with a second polarization, transverse to the first polarization, is reflected.

16. A device manufacturing method, comprising:
projecting a patterned beam of radiation onto a target portion of a substrate; and
enhancing the spectral purity of a radiation beam by reflecting radiation of a first wavelength and allowing radiation of a second wavelength to transmit through a spectral filter assembly, the first wavelength being larger than the second wavelength, wherein in a first step radiation of the first wavelength with a first polarization is reflected and in a second step radiation of the first wavelength with a second polarization, transverse to the first polarization, is reflected.

17. A device manufactured according to a method, the method comprising:
projecting a patterned beam of radiation onto a substrate;
enhancing the spectral purity of the radiation beam by reflecting radiation of a first wavelength and allowing radiation of a second wavelength to transmit through a spectral filter assembly, the first wavelength being larger than the second wavelength, wherein in a first step radiation of the first wavelength with a first polarization is reflected and in a second step radiation of the first wavelength with a second polarization, transverse to the first polarization, is reflected.

18. A device according to claim 17, wherein the device is selected from a group comprising an integrated circuit, an integrated optical system, a guidance and detection pattern for a magnetic domain memory, a liquid crystal display, and a thin-film magnetic head.
